(19) United States
(12) Patent Application Publication
(10) Pub. No.: US 2018/0369619 A1
(43) Pub. Date: Dec. 27, 2018

(54) OXYGEN-GENERATING CAPSULE

(71) Applicants: Dror NIV, Atzmon (IL); PURECARE DENTAL LTD, Ra'anana (IL)

(72) Inventors: Eliyahu DAVID, Yodfat (IL); Dror NIV, Atzmon (IL)

(73) Assignee: PURECARE DENTAL LTD, Ra'anana (IL)

(21) Appl. No.: 16/065,149

(22) PCT Filed: Dec. 20, 2016
(86) PCT No.: PCT/IL2016/051359

§ 371 Date: Jun. 22, 2018

Related U.S. Application Data
(60) Provisional application No. 62/270,629, filed on Dec. 22, 2015.

(51) Int. Cl. A62B 21/00; A62B 7/08; B01J 7/02; C01B 13/02

(52) U.S. Cl. CPC A62B 21/00; C01B 13/0207; B01J 7/02; A62B 7/08

(57) ABSTRACT

Provided relates to a capsule for the generation of oxygen, typically a disposable capsule. The generation of oxygen is by a chemical reaction of a reactant with water. The capsule is configured to be coupled with an appliance for the supply of oxygen and its utilization within the appliance. The chemical reaction occurs within the capsule when coupled with the appliance upon introduction of water thereinto through an a priori sealed port.

### TECHNOLOGICAL FIELD

The present invention concerns a capsule for generating oxygen and an appliance in which it may be utilized.

### BACKGROUND

Capsules for the generation of oxygen are known. However, the capsules known in the art produce oxygen in a high exothermic reactions, such as in a chlorate candle exemplified in U.S. Pat. No. 3,861,880. These oxygen-generating solutions cannot be employed in a domestic appliances used by a layperson.

### GENERAL DESCRIPTION

The present disclosure relates to a capsule for the generation of oxygen, typically a disposable capsule. The generation of oxygen is by a chemical reaction of a reactant with water. Reactions for the generation of oxygen involving water as one of the reactants are typically low exothermic reactions. This means that the oxygen-generating reaction involves only mild heating of the participating elements—the capsule, the reactant and the water. This allows the capsule to be made from thermoplastic materials which are relatively cheap and since the capsule is not heated into high temperatures it can be easily handled, without heat protection means (e.g. with bare hands), during or right after the reaction take place therewithin. The reactant may be sodium percarbonate (Na₂CO₃.1.5H₂O₂). The capsule may also comprise a catalyst such as manganese dioxide (MnO₂).

The capsule is configured to be coupled with an appliance for the supply of oxygen and its utilization within the appliance. The chemical reaction occurs within the capsule when coupled with the appliance upon introduction of water thereinto through an a priori sealed port. The port is configured for fluid-tight coupling to a coupling arrangement of the appliance that is linked to a water conduit system. Upon such coupling, the port is opened, water can be introduced into the capsule and oxygen is then chemically generated. The exclusion of water, one of the reactants of the chemical reaction, from the capsule, prevents an unwanted reaction and makes the capsule safe for transportation and storage.

The coupling arrangement may also be linked to an oxygen conduit system to thereby permit generated oxygen to flow out of said port into the oxygen conduit system. Alternatively, the capsule may have two ports—one for coupling to a first coupling element linked to a water conduit system for the introduction of water into the capsule and one for coupling to a second coupling element linked to an oxygen conduit system for the collection and channeling of oxygen generated within the capsule.

The capsule is formed with a housing, defining an enclosure, having one or more compartments therein. The housing is typically made from a fluid-impermeable and particularly water and moisture-impermeable material such as plastic or metal. At least one of said compartments comprises a dry reactant, typically in powder form. The capsule further has one or more sealed ports (typically, but not exclusively, one) to the capsule's interior. The sealed ports is configured to be opened, e.g. by rupturing. Such rupturing may be by a lance integrally formed within the capsule and operable to rupture the seal upon coupling or by an element of the coupling arrangement. The oxygen that is generated within the capsule then flows into an oxygen conduit. Upon a contact with water, the dry reactant reacts in a chemical reaction that generates oxygen, which flows through the opened port into oxygen conduit system of the appliance.

In one embodiment, the capsule can have at least two compartments separated by a partition, wherein a first compartment comprises the dry reactant and is spaced apart from the sealed opening by at least a second compartment. The partition separating the compartments can be a membrane that is ruptured upon said coupling or dissolved upon contact with water.

The capsule can further comprises a catalyst for the oxygen-generating reaction. The catalyst can be maintained in the same compartment as the dry reactant or in a separate compartment, wherein upon a rupture of the partition between the compartments, the catalyst mixes with the dry reactant.

By some embodiments the capsule comprises a safety valve for release of excess pressure from within the capsule.

As noted above, introducing water into the capsule initiates an oxygen-generating reaction. In some cases, for increasing the rate of the supplied oxygen to the receiving appliance, means for increasing the rate of the oxygen-generating reaction may be provides. Such means, by one embodiment, may be constituted by a stirring element (e.g. magnetic-bases) disposed in at least one of the compartments. The stirring element can be configured to be operable by the appliance, e.g. upon association of the capsule with the appliance or upon the introducing of water into the capsule.

By an embodiment of this disclosure, a high rate of reaction and hence a high rate of oxygen generation, is achieved by forming channels in said at least one compartment configured for allowing flow of water therethrough from an upper portion of the compartment to lower portions. By another embodiment a high reaction rate may be achieved by an agitation or vibration mechanism.

The capsule may bear a tag or indicia (e.g. barcode, RFID, mechanical tagging label, etc.) readable by a reader within the appliance, to affect the operation thereof (e.g. amount of water, time period of operating an ozone generator that generates ozone from the oxygen, application of the stirring, agitating or vibrating mechanism, etc.) to match the specific parameter of the capsule. Also, such a tag or indicia may be design to prevent accidental re-use of the capsule.

Another aspect of the present disclosure concerns an appliance that is (1) configured for receiving a capsule of the kind specified; (2) comprises a water-introducing flow system that is configured for (i) associating with the capsule in a fluid-tight manner, (ii) introducing water thereinto and (iii) providing condition for oxygen generation; and configured for (3) utilizing the oxygen.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic longitudinal cross-section of a capsule of an embodiment of the present disclosure.

FIGS. 2-3 are schematic longitudinal cross-sections of other embodiments of the capsule of the present disclosure that comprise a catalyst, in addition to the reactant.

FIG. 4 is a schematic longitudinal cross-section of a capsule of another embodiment of this disclosure formed with channels for channeling water from upper portions of the reactant-containing compartment to lower portions thereof.

FIG. 5 is a schematic longitudinal cross-section of a capsule of another embodiment of this disclosure that comprises a magnetic stirring element.

FIG. 6 is a schematic illustration exemplifying association of a capsule of an embodiment of this disclosure with a coupling arrangement of an appliance.

FIG. 7 is a schematic illustration of an exemplary embodiment of an appliance of this disclosure.

### DETAILED DESCRIPTION OF EMBODIMENTS

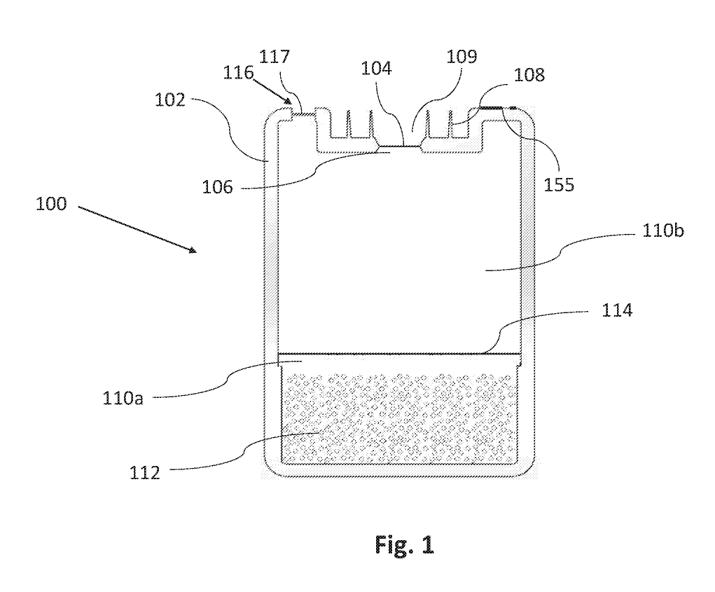

FIG. 1 shows a capsule 100 having a housing 102, typically made of an impervious materials such as plastic or metal, with a port 106 at the center of a concentric depression 109, sealed by reputable seal 104. The seal may be ruptured open by an element, e.g. a lance, of a coupling arrangement (not shown) of an appliance, as also exemplified below in non-limiting manner Surrounding port 106 are upwardly abutting concentric elastomeric sealing elements 108 that provide for a sealed coupling with the coupling arrangement. Thus, rings 108 prevent any gas leakage from the capsule 100 to the surrounding. The capsule 100 has two compartments, a first, reactant compartment 110A and a second, spacer compartment 110B.

Reactant compartment 110A holds a dry reactant 112, typically in powder or granulated form. The dry reactant 112 is of a kind such that its contact with water initiates an oxygen-generating reaction.

The reactants compartment 110A and the spacer compartment 110B are separated by a partition 114. The partition 114 is dissolvable by water and, thus, upon contact with water it disintegrates permitting contact between the water and reactant 112. By another embodiment, the partition may be ruptured by an element of the appliance's coupling arrangement. By a further embodiment, the capsule may have an integral lance element that is displaced to rupture partition 114 upon coupling of the capsule with the coupling arrangement. The inclusion of partition 114 and spacer compartment provide an extra safety measure against contact of the reactants with moisture that may be leaked into the capsule, in the case integrity of seal 104 is severed for any reason, e.g. as a result of mishandling during transportation and/or storage. As can be appreciated, such unwanted entry of moisture may induce unwanted oxygen-generating reaction.

As will be appreciated and also described further below, the capsule of other embodiments may have other than 2 compartments. For example, a capsule of this disclosure may have a single, reactant-holding compartment or may have 3 compartments, one of which holds a reactant and another holding a catalyst.

Contact of moisture with the dry reactant may initiate an oxygen-generating reaction that may cause deterioration of the material. Thus, to prevent this unwanted reaction, the interior of the capsule (or at least its reactant-containing compartment) can be under vacuum.

Once water is introduced into the capsule 100 and contacts the dry reactant, the reaction in which oxygen is generated, is initiated and exits through the opening to an oxygen conduit system (see below). For the case that, for any reason, a pressure within the capsule increases due to an accumulated generated oxygen that does not exit through the port 106, the capsule 100 is provided with a safety valve 116. The safety valve 116 is integrally formed in the housing 102 and is configured for opening (e.g. through pressure-induced rupturing of its seal 117, once the pressure inside the capsule reaches a predefined threshold, to thereby release the pressurized gas within the capsule 100 through the safety valve 116.

The capsule 100 can have a mark or a tag 155, typically located on the exterior of the housing, carrying data indicative for the operation of the appliance. The mark 155 is readable by the appliance configured to receive the capsule 100 and may be in a form of radiation response system (e.g. RFID, barcode), mechanically marking or other data indicative readable markings known in the art. The operation of the appliance may be affected by the data carried by the mark 155. For example, where the capsule is received in an ozone-generating appliance, the data of the mark 155 can induce an increased or decreased in operation time of an ozone-generating electrode. In another example, the data that is carried by the mark 155 can prevent reuse of a used capsule.

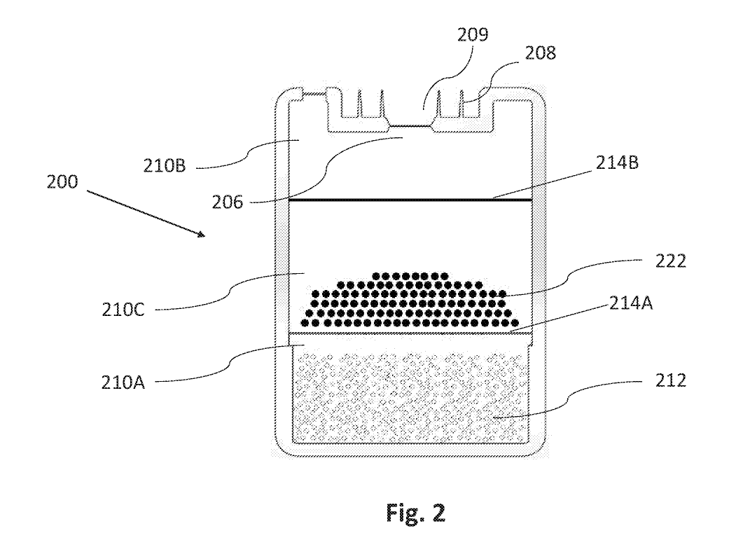

In FIGS. 2, 3, 4, 5 and 6, like elements to those of FIG. 1 were given like reference numerals shifted, respectively, by 100, 200, 300, 400 and 500. Thus, for example, element 202 in FIG. 2, serves the same function as element 102 in FIG. 1

Reference is now made to FIG. 2, that shows a capsule 200 that comprises three compartments including a reactant compartment 210A, holding the chemical reactant 212, a catalyst compartment 210B on top of the reactant compartment 210A, holding a catalyst 222, typically in powder or granulated form, that catalyzes an oxygen-generating reaction between the reactant and water, and a third, uppermost spacer compartment 210C. The compartments are separated by partitions 214A and 214B, formed between compartments 210A and 210B and between compartments 210B and 210C, respectively.

Upon entry of water through the opened port 206, partition 214B is disintegrated, permitting water entry into compartment 210B to thereby subsequently cause disintegration of partition 214A and the consequent oxygen-generating reaction by the reactant 212 catalyzed by catalyst 222.

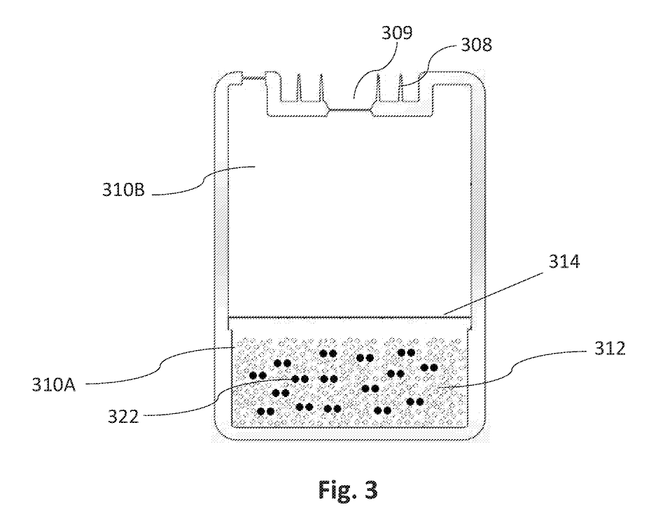

The capsule 300 shown in FIG. 3 differs from that of FIG. 2 by having only two compartments 310A and 310B, with a general structure similar to that of the capsule of FIG. 1, and by the inclusion of the catalyst 322 in the same compartment as reactant 312.

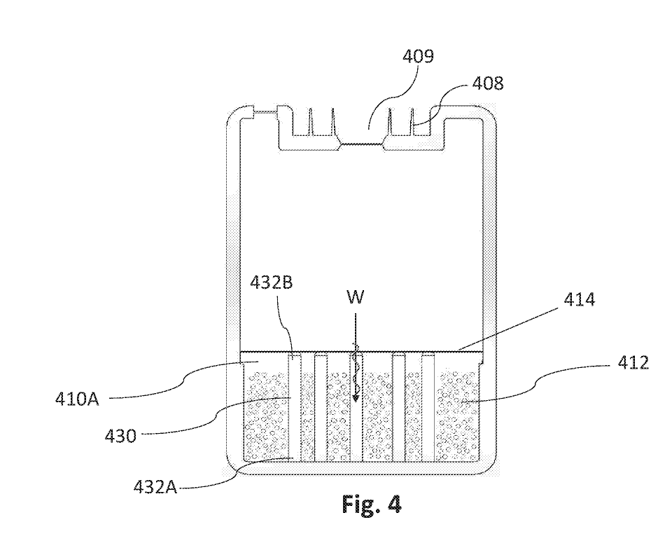

The capsule 400 shown in FIG. 4, has also two compartments, 410A and 410B, with similar function to those of the corresponding compartments of the capsule of FIG. 1. Channels, defined by conduits 430, are formed within compartment 410A that function to channel water from the upper portion 432B of the compartment to its lower portion 432A in the general direction of arrow W, after disintegration or rupture of partition 414, to thereby accelerate rate of the oxygen-generating reaction. The conduits 430 are leaky to allow the flow of water to surrounding portions of reactant 412.

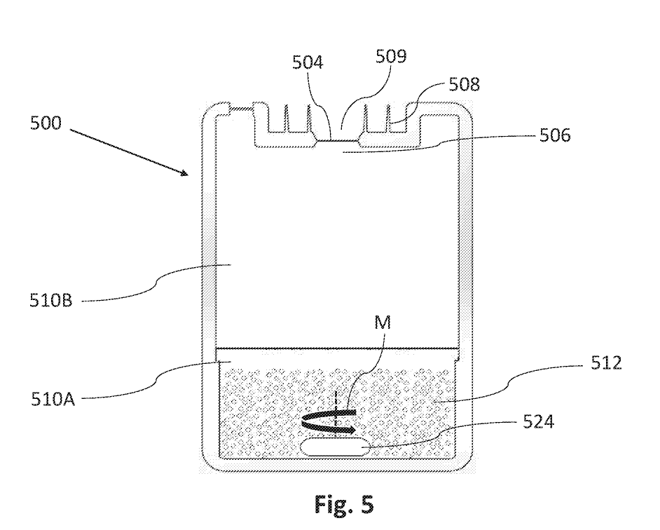

Reference is now being made to FIG. 5 which shows a capsule 500 having two compartments 510A and 510B separated by partition 514. Compartment 510A holds a chemical reactant 512. Also included in compartment 510A is a magnetic stirring element 524 that can revolve around an axis, as represented by arrow M, by induction of an external magnetic stirring mechanism which is part of the appliance (not shown). Once water is introduced into the capsule 500 through port 506 (after breaking seal 504), the magnetic stirring mechanism is activated to thereby induce rotation of the magnetic stirring element 524. This stirring increases the rate of the oxygen-generating reaction and hence faster oxygen generation and output out of port 506.

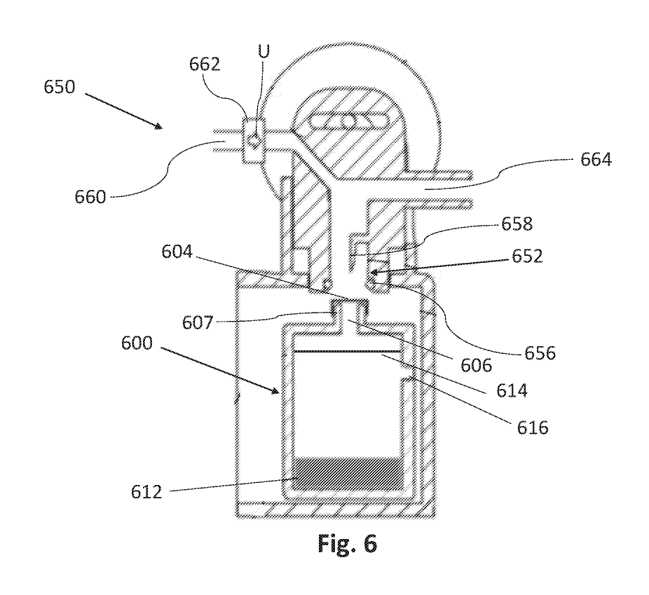

FIG. 6 illustrates an example of a coupling arrangement 650 configured for coupling with capsule 600. Capsule 600 has a port 606 that is at the top of a short neck 607 and sealed by seal 604. The capsule includes a reactant 612 and safety valve 616. The coupling arrangement 650 comprises a neck receptacle 652 with O-ring 656 that once the neck is fitted into receptacle 652 forms a fluid-tight seal with the capsule.

A lance element 658 is included in the coupling arrangement 650 and once the capsule is elevated from the position shown in FIG. 6, such that its neck 607 is received within receptacle 652, seal 604 is ruptured by lance element 658 to open port 606. By some embodiments the position of the lance, its length and the position of partition 614 may be configured such that the lance in addition to rupturing seal 604 also ruptures optional partition 614, which is an optional inclusion within the capsule. It should be noted, that coupling between the capsule and the coupling arrangement may also be obtained by lowering the coupling arrangement 650 towards the capsule by a lowering mechanism (not shown).

The neck receptacle 652 is in fluid communication with a water flow system of which terminal segment 660 is shown; that is fitted uni-directionally with a control valve 662 (that permits flow only in the direction represented by arrow U); and is also in flow communication with an oxygen conduit system of which only the initial segment 664 is shown.

Once the capsule 600 is coupled to the coupling arrangement 650 by lifting it upward manually or through an elevating mechanism (not shown), valve 662 is opened, permitting a volume of water to ingress into capsule 600. The resulting chemical reaction generates oxygen which then egresses through port 606 to flow into segment 664 and then into the oxygen conduit system for utilization by the appliance.

While the formation of fluid-tight coupling in the embodiment seen in FIG. 6 is through tight association of O-ring 656 with the outer surface of neck 607, such fluid-tight association would be different in the case of a capsule having a housing of the kind seen in FIGS. 1-5, where the fluid-tight association is ensured by concentric elastomeric sealing elements 108, 208, 308, 408, 508 which compress against an opposite flat surface of a coupling element, with a central opening (linked to the water conduit system and the oxygen conduit system) that would fit into the depressed central portion 109, 209, 309, 409, 509 of the capsule.

In addition, in a coupling arrangement for coupling with a capsule, of the kind seen in FIGS. 1-5, the element for breaking or rupturing seal 504 will accordingly be differently configured than in FIG. 6.

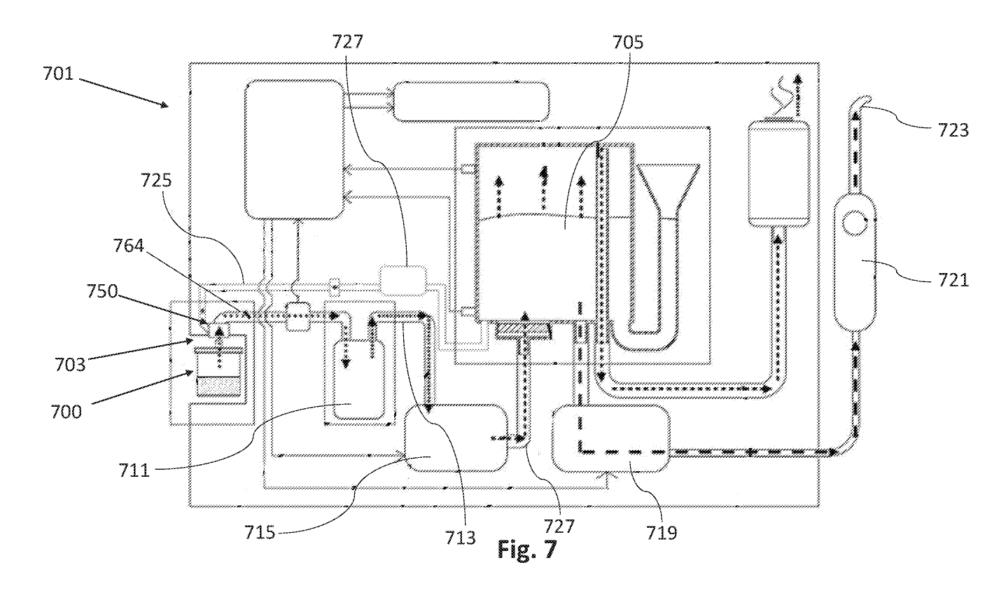

FIG. 7 is a schematic illustration of an appliance of an embodiment of this disclosure. Appliance 701 is an exemplary appliance for the production and use of ozonated water for the treatment of gums (similar in intended use to that disclosed in PCT Application with a publication No. WO 2016/012998).

The appliance 701 includes water reservoir 705 which is linked, through a pump 727, by a water flow system 725 with the coupling arrangement 750, at the top of receptacle 703. Also linked to the coupling arrangement is an oxygen conduit system 764 which includes an oxygen filter 711 linked through conduit segment 713 to an ozone generator 715, then flows through conduit 727 to reservoir 705 to ozonate the water in the reservoir which can then be pumped, by pump 719, to a jet applicator 721 for delivery to an ozonated water jet out of nozzle 723 to the gums.

The appliance includes other elements of the kind generally disclosed in the aforementioned PCT Application No. WO 2016/012998.

1.-12. (canceled)

13. A capsule for an appliance, comprising:
a housing defining an enclosure with one or more compartments, at least one of the compartments comprising a dry reactant that upon contact with water participates in an oxygen-generating reaction;
the housing having a sealed port that is configured for opening by and for a fluid-tight association with a water-introducing flow system of the appliance;
a mark carrying data indicative for operation of the appliance and readable by a reader of the appliance; and
wherein the capsule is configured for coupling with the appliance, the appliance being an ozone-generating appliance comprising an ozone generator that can generate ozone from the oxygen, the data of the mark affects the operation of the ozone generator.

14. The capsule of claim 13, wherein the dry reactant is in powder form.

15. The capsule of claim 14, comprising at least two compartments separated by a partition, wherein a first compartment comprises said dry reactant and is spaced apart from the sealed port by at least one second compartment.

16. The capsule of claim 15, wherein the partition is a membrane that is ruptured upon contact with water or by a pressure induced by a rupturing element.

17. The capsule of claim 13, wherein at least one of the compartments comprises a catalyst for the oxygen-generating reaction.

18. The capsule of claim 13, further comprising a safety valve for releasing excess gas pressure.

19. The capsule of claim 13, wherein at least one of the compartments is under vacuum.

20. The capsule of claim 13, comprising a stirring element operable by a stirring mechanism of said appliance, for stirring content of the capsule.

21. The capsule of claim 20, wherein said stirring mechanism is activated after introduction of water into the capsule.

22. The capsule of claim 13, wherein said at least one compartment is formed with channels configured for allowing flow of water therethrough from an upper portion of the compartment to lower portions.

23. The capsule of claim 13, wherein the data carried by the mark affects the operation time of an ozone-generating electrode and/or prevents reuse of the capsule.

24. A capsule for an appliance, comprising:
a housing defining an enclosure with one or more compartments, at least one of the compartments comprising a dry reactant that upon contact with water participates in an oxygen-generating reaction;
the housing having a sealed port that is configured for opening by and a fluid-tight association with a water-introducing flow system of the appliance;
wherein the compartment comprising the dry reactant is formed with channels configured for allowing flow of water therethrough from an upper portion of the compartment to lower portions.

25. An appliance
configured for receiving a capsule of claim 13; and
comprising a water-introducing flow system that is configured for associating with the capsule in a fluid-tight manner, introducing water thereinto and providing condition for oxygen generation; and configured for utilizing the oxygen.

26. An appliance
configured for receiving a capsule of claim 24; and
comprising a water-introducing flow system that is configured for associating with the capsule in a fluid-tight manner, introducing water thereinto and providing condition for oxygen generation; and configured for utilizing the oxygen.
